(19) United States
(12) Patent Application Publication
(10) Pub. No.: US 2026/0180664 A1
(43) Pub. Date: Jun. 25, 2026

(54) WIRELESS DIRECTION FINDING USING MULTIPLE FREQUENCY BANDS

(71) Applicant: Microsoft Technology Licensing, LLC, Redmond, WA (US)

(72) Inventors: Jason HARRIGAN, Sultan, WA (US); Tero J. PATANA, Kirkland, WA (US)

(73) Assignee: Microsoft Technology Licensing, LLC, Redmond, WA (US)

(21) Appl. No.: 18/988,496

(22) Filed: Dec. 19, 2024

(51) Int. Cl. H04B 7/08; H04B 7/0426; H04W 64/00

(52) U.S. Cl. CPC H04B 7/086; H04B 7/043; H04W 64/006

(57) ABSTRACT

This document relates to direction finding for beam steering in wireless communication applications. The disclosed implementations can employ various signal characteristics to determine a direction in which to steer a radio frequency beam for wireless communication. For example, a first radio of a communication device can be employed for direction finding of another communication device using signals in a first frequency band. Based on directional information obtained from the first radio, a second radio can be instructed to initialize a search for the another communication device using signals in a second frequency band that is higher than the first frequency band.

### BACKGROUND

Wireless technologies are employed for a wide range of communication scenarios, ranging from very long-range communications (e.g., from earth to a satellite) to very short-range communications (e.g., near-field computing). In many cases, omnidirectional antennas that radiate unfocused radio frequency energy are employed. However, this approach can be wasteful of processing and energy resources, and can also result in crowding of radio frequency spectrum. Furthermore, depending on the link budget, omnidirectional antennas may not ensure sufficient signal-to-noise ratio (“SNR”) to establish and maintain a given communications link.

One high-level approach for more efficient radio frequency communication involves using one or more antennas to send a focused radio frequency beam toward another device. This approach can increase SNR and reduce wasteful expenditure of processing, energy, and spectrum resources. However, it can be difficult and/or time-consuming to accurately find the direction in which to send a focused beam. This problem becomes even more difficult when two devices are moving relative to one another while attempting to maintain a reliable wireless link.

### SUMMARY

This Summary is provided to introduce a selection of concepts in a simplified form. These concepts are further described below in the Detailed Description. This Summary is not intended to identify key features or essential features of the claimed subject matter, nor is it intended to be used to limit the scope of the claimed subject matter.

The description generally relates to techniques for wireless direction finding. One example includes a computer-implemented method that can include receiving, with a first radio configured to communicate in a first frequency band, one or more first signals transmitted in the first frequency band by another communication device. The method can also include receiving, from the first radio, directional information for the another communication device, the directional information of the another communication device having been determined by the first radio based at least on angle of arrival of the one or more first signals. The method can also include instructing a second radio to initialize a search for the another communication device based at least on the directional information received from the first radio, the second radio being configured to communicate in a second frequency band that is relatively higher than the first frequency band. The method can also include instructing the second radio to communicate with the another communication device over a communication link established via the search, where the second radio performs the search and establishes the communication link by transmitting one or more second signals in the second frequency band.

Another example entails a computer-implemented method that can include using a first radio configured to communicate in a first frequency band for transmitting one or more first signals in the first frequency band and receiving at least one response to one or more first signals from another communication device, the at least one response representing channel conditions for the first frequency band estimated by the another communication device based on the one or more first signals. The method can also include receiving, from the first radio, directional information for the another communication device, the directional information for the another communication device being determined by the first radio based at least on the channel conditions for the first frequency band received from the another communication device. The method can also include instructing a second radio to initialize a search for the another communication device based at least on the directional information received from the first radio, the second radio being configured to communicate in a second frequency band that is relatively higher than the first frequency band. The method can also include instructing the second radio to communicate with the another communication device over a communication link established via the search, where the second radio performs the search and establishes the communication link by transmitting one or more second signals in the second frequency band.

Another example includes a communication device. The device can include a wireless communication circuit having a first radio with multiple first antenna elements and a second radio with multiple second antenna elements, the first radio being configured to communicate in a first frequency band and the second radio being configured to communicate in a second frequency band that is higher than the first frequency band. The device can also include a processing circuit in communication with the first radio and the second radio. The first radio can be configured to transmit one or more first signals in the first frequency band. The first radio can also be configured to receive at least one response to the one or more first signals from another communication device, the at least one response representing channel conditions for the first frequency band estimated by the another communication device based on the one or more first signals. The processing circuit can be configured to receive, from the first radio, directional information for the another communication device, the directional information for the another communication device being determined by the first radio based at least on the channel conditions for the first frequency band received from the another communication device. The processing circuit can also be configured to instruct the second radio to initialize a search for the another communication device based at least on the directional information received from the first radio. The processing circuit can also be configured to instruct the second radio to communicate with the another communication device over a communication link established via the search. The second radio can be configured to perform the search and establish the communication link by transmitting one or more second signals in the second frequency band.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example wireless communication circuit, consistent with some implementations of the present concepts.

FIG. 2 illustrates an example hardware architecture, consistent with some implementations of the present concepts.

FIGS. 3A-3C illustrate an example satellite communication scenario, consistent with some implementations of the present concepts.

FIGS. 4A-4E illustrate an example cellular communication scenario, consistent with some implementations of the present concepts.

FIGS. 5A-5D illustrate a communication scenario involving two moving vehicles, consistent with some implementations of the present concepts.

FIGS. 6A-6E illustrate an example scanning pattern, consistent with some implementations of the present concepts.

FIG. 7 illustrates an example of a system in which the disclosed implementations can be performed, consistent with some implementations of the present concepts.

FIG. 8 illustrates an example method or technique, consistent with some implementations of the disclosed techniques.

FIG. 9 illustrates an example method or technique, consistent with some implementations of the disclosed techniques.

### DETAILED DESCRIPTION

### OVERVIEW

As noted above, directional wireless communication techniques can have significant advantages over omnidirectional communication techniques. However, it can be difficult to accurately focus a directed radio frequency beam in the correct direction to target a receiving device. This technical challenge is even more significant in circumstances where one or both devices are moving, as the direction that the beam should be focused in changes over time.

Complicating matters, recent technologies have trended toward using relatively higher frequencies for radio communication, such as millimeter-wave (mmWave) bands (24 GHz to 100 GHz) and even terahertz (THz) bands. Relatively higher frequencies have various advantages over lower frequencies, such as higher bandwidth. On the other hand, given the same antenna size, a higher-frequency radio beam has a narrower spread than a lower-frequency radio beam. As a consequence, it becomes even more difficult to accurately aim a focused radio beam at another device when higher frequencies are used.

The disclosed implementations can employ various signal characteristics to determine a direction to focus a radio frequency beam for wireless communication. For example, a communication device can employ one or more first signals communicated in a first frequency band using a first signal to find the direction of another communication device. Then, that information can be employed to initiate a search for the other communication device using a second radio that communicates in a second, relatively higher frequency band. A communication link can be established and maintained using a relatively narrow, high-frequency beam employed by the second radio. In some implementations, the direction-finding process is performed repeatedly, e.g., periodically using the first radio for direction finding and using that information to update the direction used by the second radio, thus maintaining the communication link. Because the first radio can use a relatively wide, low-frequency beam for direction finding, the search for the other communication device can be performed more efficiently than if only the second radio were employed.

### EXAMPLE RADIO CIRCUIT

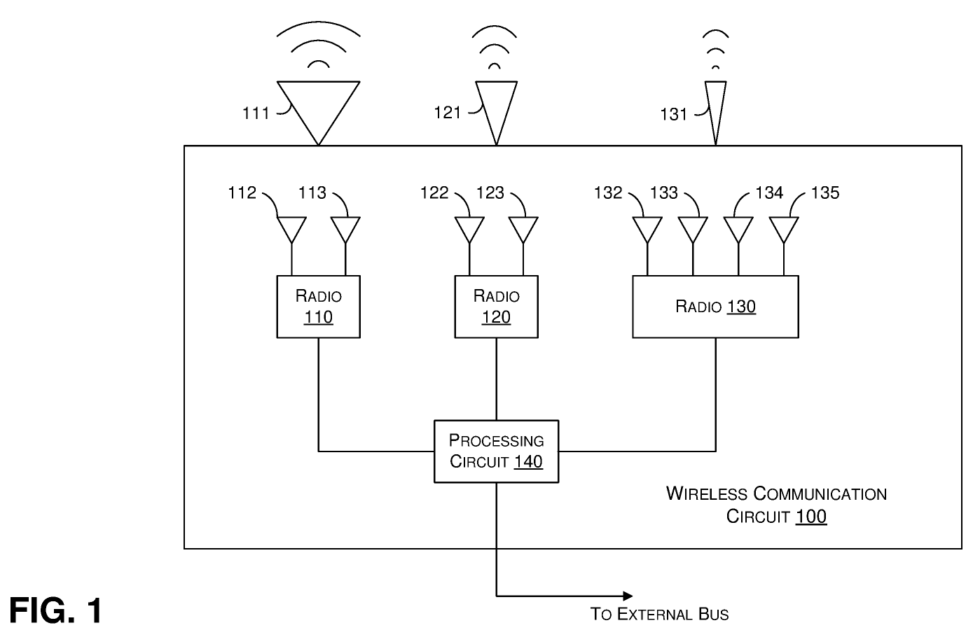

FIG. 1 shows an example wireless communication circuit 100 with a radio 110, a radio 120, and a radio 130 connected to a processing circuit 140. Radio 110 transmits radio signals having a beamwidth 111 at frequency f1 using antenna element 112 and antenna element 113, radio 120 transmits radio signals having a beamwidth 121 at frequency f2 using antenna element 122 and antenna element 123, and radio 130 transmits radio signals having a beamwidth 131 at frequency f3 using antenna element 132, antenna element 133, antenna element 134, and antenna element 135. Assuming all antennas are of similar size, e.g., the sum of the areas of the antenna elements is equal, and the frequencies f1<f2<f3, then the antenna beamwidths will be bw1>bw2>bw3, as conveyed by the relative angular widths shown in FIG. 1. The term “beamwidth” refers to the angular width of the main lobe of the radiation pattern of a given antenna, e.g., a half-power or 3 decibel beamwidth.

In some implementations, f1 is in a 700 MHz band (e.g., from 698 MHz to 806 MHz), f2 is in a 2.4 GHz band (2.4 GHz to 2.5 GHz) or 5 GHz band (5.150 GHz to 5.825 GHz), and f3 is in a 60 GHz band (e.g., 57 GHz to 64 GHz). However, these are merely examples and the disclosed techniques can be implemented using various other frequencies. Because beamwidth can vary as a function of frequency and antenna size or gain, terms used herein such as “wide” and “narrow” beamwidths are used in a relative sense to convey the relative areas covered by a given signal transmitted by a given antenna at a given frequency. For example, a 700 MHz band signal might have a beamwidth of 100 degrees, a 5 GHz band signal might have a beamwidth of 30 degrees, and a 60 GHz band signal might have a beamwidth of 10 degrees. However, these are merely example values, and the disclosed techniques can be employed using signals with a wide range of beamwidths that vary as a function of antenna and frequency characteristics.

Processing circuit 140 can be a central processing unit (CPU), a digital signal processor (DSP), an application-specific integrated circuit (ASIC), a field-programmable gate array (FPGA), etc., with an internal or external memory having instructions. The processing circuit can generate various digital waveforms that can be sent to the respective radios. For instance, the processing circuit can generate digital signals using error correction codes, modulation schemes such as quadrature phase shift keying and quadrature amplitude modulation, beamforming weights, etc. The beamforming weights can include individual phase and amplitude values for each antenna element of a given radio.

The processing circuit 140 can send the digital signals to the respective radios which can then perform digital-to-analog conversion of the digital waveforms into analog signals. For instance, the radio 110 can perform digital-to-analog conversion of digital signals received from the processing circuit into analog signals at carrier frequency f1. The antenna elements 112 and 113 can focus a beam at frequency f1in a specific direction based on the beamforming weights applied by the processing circuit. Likewise, the radio 120 can perform digital-to-analog conversion of digital signals received from the processing circuit into analog signals at carrier frequency f2. The antenna elements 122 and 123 can focus a beam at frequency f2 in a specific direction based on the beamforming weights applied by the processing circuit. In addition, the radio 130 can perform digital-to-analog conversion of digital signals received from the processing circuit into analog signals at carrier frequency f3. The antenna elements 132, 133, 134, and 135 can focus a beam at frequency f3 in a specific direction based on the beamforming weights applied by the processing circuit.

Note that wireless communication circuit 100 can be implemented as a system with multiple discrete radio circuits connected to a processor, or it can represent a single integrated circuit. In some cases, the individual radios may have their own internal signal-generating capabilities. For instance, the processing circuit 140 may coordinate synchronization and timing across each individual radio, but the radios themselves may generate the digital signals internally. Also, note that processing circuit may be implemented using fixed logic circuitry, or may include an internal memory with executable instructions.

In addition, note that the respective radios may implement their own direction-finding algorithms independently. For instance, each radio may have beamforming circuitry and scanning logic to initiate a search for other communication devices using a scanning pattern and/or a coding scheme. In some implementations, the processing circuit 140 can receive directional information from one radio indicating the direction of another communication device. The processing circuit can then instruct another radio to initiate a search for the other communication device based on the directional information. In these implementations, each radio can use its own independent direction-finding algorithm, but the direction-finding algorithms are informed by directional information shared among the independent radios by the processing circuit. By sharing directional information among independent radios using the processing circuit as described herein, each radio can complete a respective search for another communication device more quickly than would be expected if each radio had to implement its own direction-finding algorithms without the shared directional information.

### EXAMPLE HARDWARE ARCHITECTURE

Wireless communication circuit 100 can be provided various types of communication devices. For instance, wireless communication circuit 100 can be implemented in mobile computing devices such as cell phones or tablets, laptop computers, desktop computers, wearable and/or augmented reality devices, televisions or other displays such as whiteboards, video game controllers, wireless access points, base stations, satellites, vehicles, etc. The following describes one general computing architecture that can be employed in such devices.

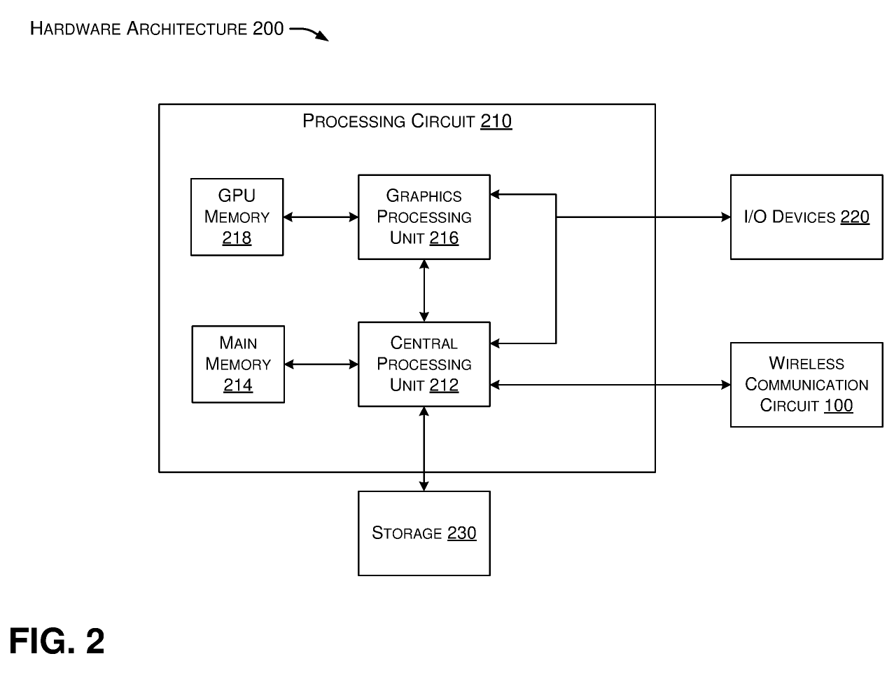

FIG. 2 shows a hardware architecture 200 including a processing circuit 210 with a central processing unit 212 having a main memory 214 and a graphics processing unit 216 or “GPU” having GPU memory 218. The processing circuit is also connected to I/O devices 220 (e.g., keyboard, display, etc.), storage 230 (e.g., a solid state storage device), and wireless communication circuit 100. The main memory can store instructions for implementing an operating system and one or more applications. The central processing unit can execute the instructions in the main memory and communicate with the graphics processing unit to render images on a display.

The central processing unit 212 can generate data packets by executing the instructions in the main memory 214. For instance, the data packets can be implemented using various protocols, including transport layer protocols such as transmission control protocol and user datagram protocol and/or network layer protocols such as Internet Protocol versions (e.g., IPv4, IPv6, etc.). The data packets can represent communications to be sent to another device using wireless communication circuit 100. The wireless communication circuit can implement data link functionality such as frame synchronization, error detection, medium access control, etc. The wireless communication circuit can also implement physical layer functionality relating to signal modulation and encoding/decoding as described elsewhere herein.

Note that FIG. 2 is a general example showing how wireless communication circuit 100 can be integrated with other hardware components, and is neither comprehensive nor limiting. For example, a hardware architecture may have various additional components not shown, e.g., an audio signal processor, additional processing units (e.g., a neural processing unit), additional memories, etc. In addition, various buses may connect the different components to communicate with one another.

### SATELLITE COMMUNICATION SCENARIO

The techniques described herein can be implemented in a wide range of scenarios using many different types of devices. The following sections introduce a few specific, concrete communication scenarios in which the disclosed techniques can be employed. However, the following scenarios are non-limiting and the disclosed techniques can be employed in any wireless communication scenario involving beamforming and/or beam steering.

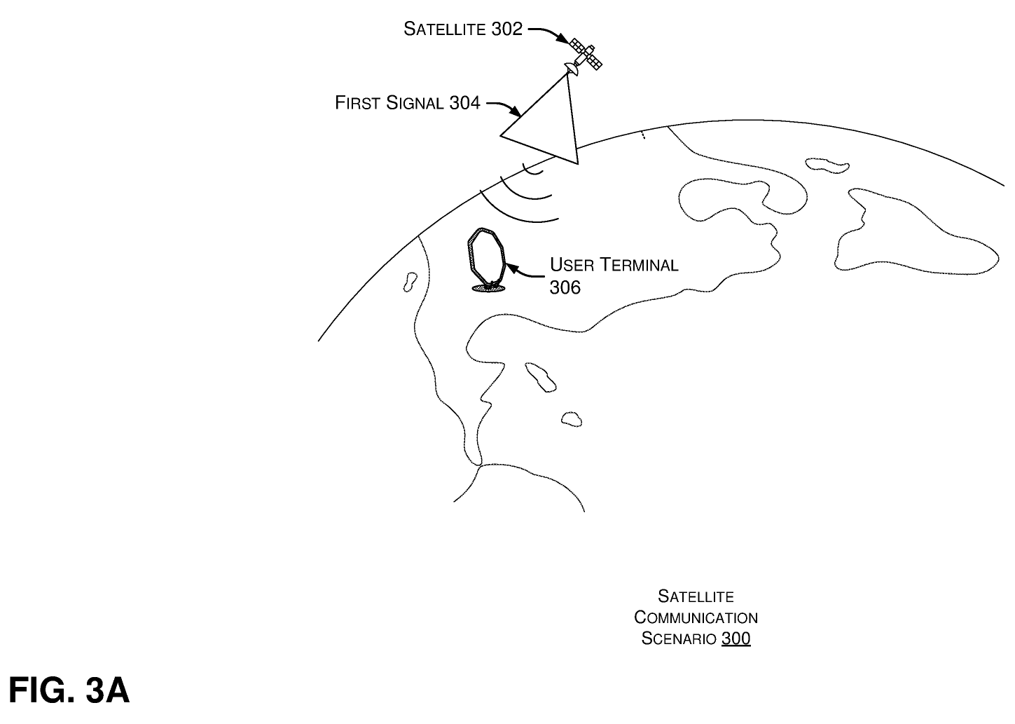

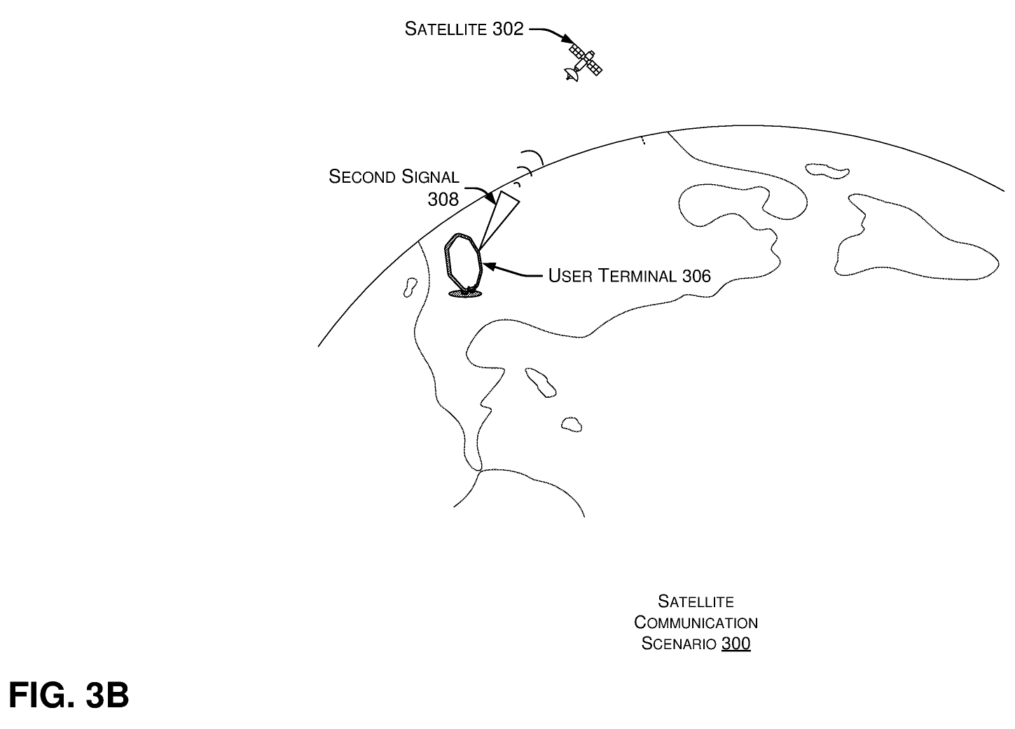

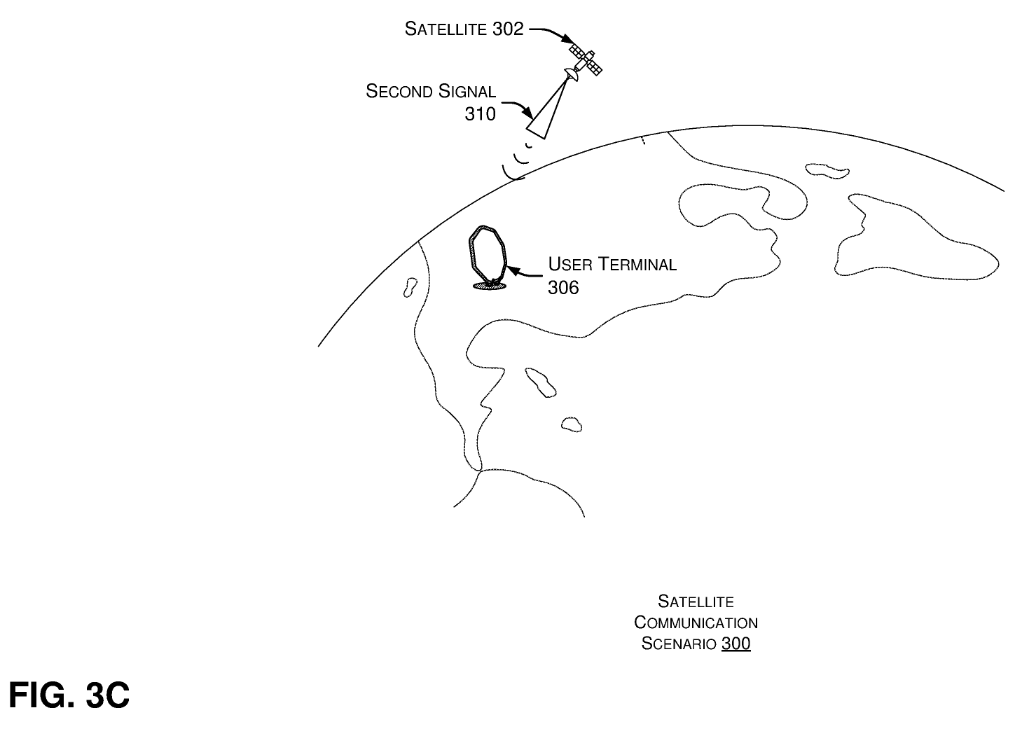

FIGS. 3A through 3C illustrate a satellite communication scenario 300. In FIG. 3A, a satellite 302 transmits a first signal 304 that is received by a user terminal 306. The satellite and/or user terminal can each include an instance of wireless communication circuit 100 as shown in FIG. 1. For instance, the first signal 304 can be a beacon signal transmitted by the satellite at a first frequency (e.g., f1). The beacon signal can be periodically retransmitted by the satellite at fixed intervals, and can include information such as a time stamp that the user terminal utilizes to synchronize its own internal clock with the satellite. The beacon signal can also include unique identifier of the satellite, transmission power levels, modulation and coding scheme information, access protocols such as TDMA (time division multiple access) or FDMA (frequency division multiple access) supported by the satellite, frame timing information, etc. The beacon signal can have predetermined characteristics (e.g., frequency, modulation scheme, a unique identifier, etc.) that are known to the user terminal so that the user terminal can identify the beacon signal.

In FIG. 3B, the user terminal 306 determines a direction of the satellite 302 using time difference of arrival processing of the first signal 304. For instance, the user terminal can compare the arrival times of the beacon signal at individual array elements of a first radio, e.g., antenna elements 112 and 113 of radio 110. The delay in the arrival times at different antenna elements and/or the difference in phase of the received signal at different antenna elements can be used to compute the arrival direction of the beacon signal. Because the first signal 304 is transmitted by the satellite at a relatively low frequency, the user terminal can use a relatively wide reception beam pattern formed by antenna element 112 and antenna element 113.

The user terminal 306 then transmits a second signal 308 to the satellite based on the direction determined using the first signal. For instance, the second signal can be transmitted at frequency f2 using radio 120 and/or frequency f3 using radio 130. Referring back to FIG. 1, this can be implemented by processing circuit 140 receiving directional information from radio 110 indicating the direction of the satellite determined by radio 110. The processing circuit can instruct either radio 120 and/or radio 130 to initialize a search for the satellite using the second signal 308. For instance, the processing circuit can employ calibration data, such as a lookup table, to account for a physical offset between the radios on the user terminal and/or different beamforming characteristics of the respective radios. Said another way, the processing circuit can use the direction of the satellite as determined by radio 110 to provide a seed or initial condition to inform a subsequent search by radio 120 and/or 130 for the satellite 302.

Next, as shown in FIG. 3C, satellite 302 can determine the angle of arrival of second signal 308 and transmit another second signal 310 to the user terminal 306. Second signal 310 can carry a communication signal to the user terminal. Note that FIG. 3C shows second signal 310 as employing a relatively narrower beamwidth than first signal 304 in FIG. 3A, but this is not necessarily the case. The user terminal can still utilize relatively narrow, high-frequency beams for communication with the satellite at frequencies f2 or f3 even if the satellite does not also use narrower beams for frequencies f2/f3.

User terminal 306 and satellite 302 can communicate using a communication link established with second signal 308 and second signal 310 over time. In the event that the communication link is lost, one or both devices can switch back to using a lower frequency to determine the direction of the other device as described above. Then, communication can be resumed using a relatively higher frequency as described elsewhere herein.

Note that FIGS. 3A-3C illustrate a relatively simple scenario where the user terminal 306 and satellite 302 have direct line-of-sight to one another without significant multipath effects. Also, note that the example shows the user terminal 306 switching from using a wide beamwidth directly to a narrow beamwidth once a direction of the satellite 302 is established. In other implementations described more below, a device can perform multiple iterations of direction finding by progressively switching from a wide beam to narrower beams that increase in frequency until a final direction is established (e.g., using frequency f2 and radio 120 as an intermediate, medium-width beam and frequency f3 as a final, narrow-width beam employed for a communication link). In some implementations, the satellite 302 may also periodically switch back to using a lower frequency even while a communication link is maintained at a higher frequency. In this manner, the user terminal can periodically confirm the direction in which to transmit the second signals used for the communication link.

### CELLULAR COMMUNICATION SCENARIO

In the satellite communication scenario described above, the satellite transmitted a beacon signal that enabled the user terminal to determine the direction of the satellite without necessarily involving active participation by the satellite. In some implementations, however, active participation can be employed where one communication device receives a signal, determines various characteristics of a wireless channel, and then sends those characteristics back to the other communication device to provide additional information that can be employed for beam steering. The following section describes one such scenario.

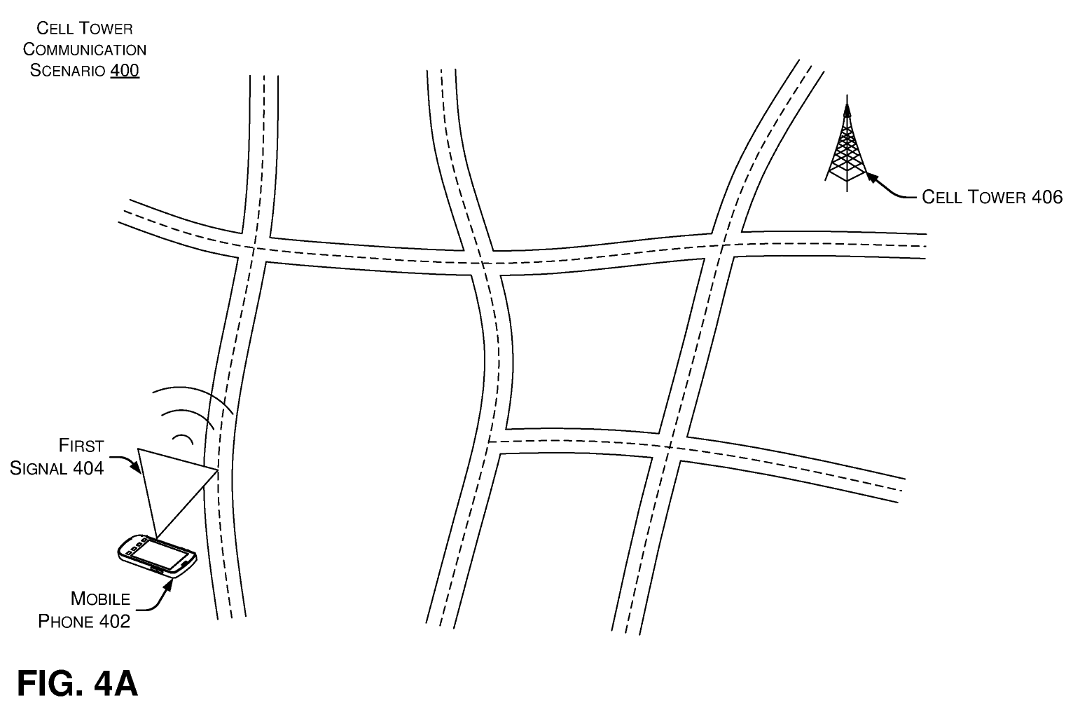

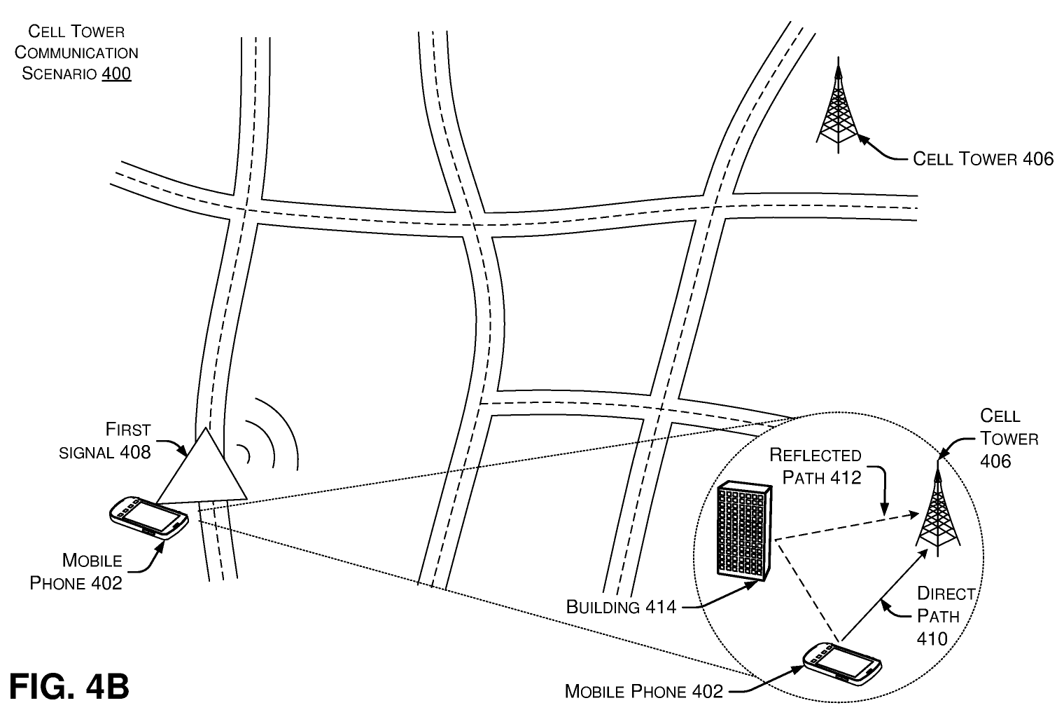

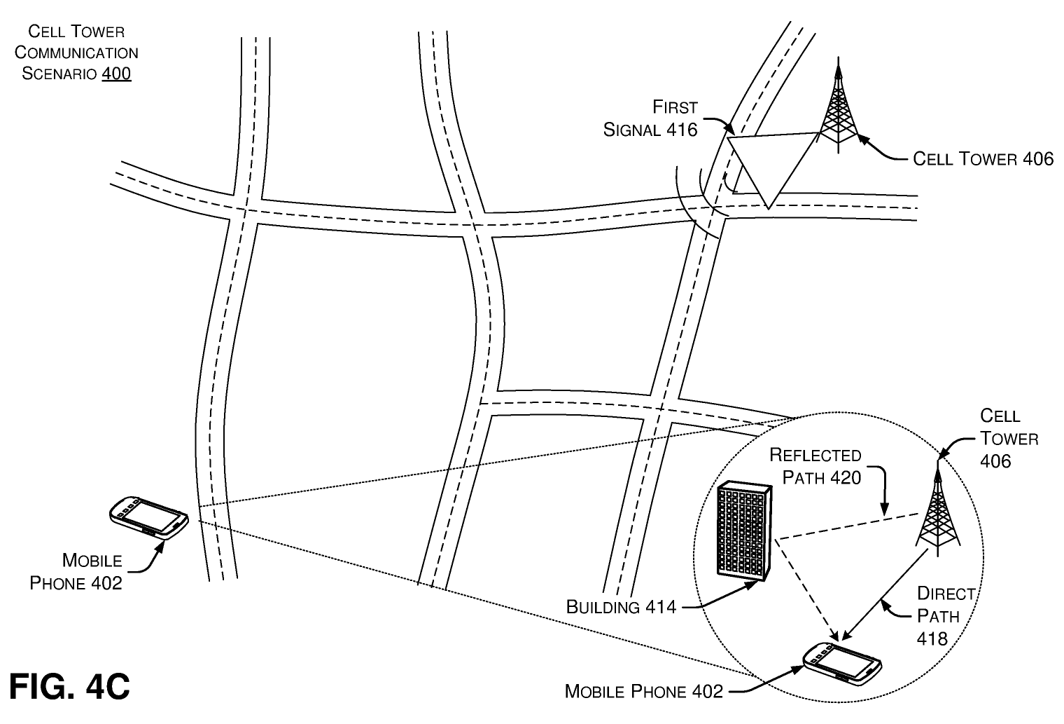

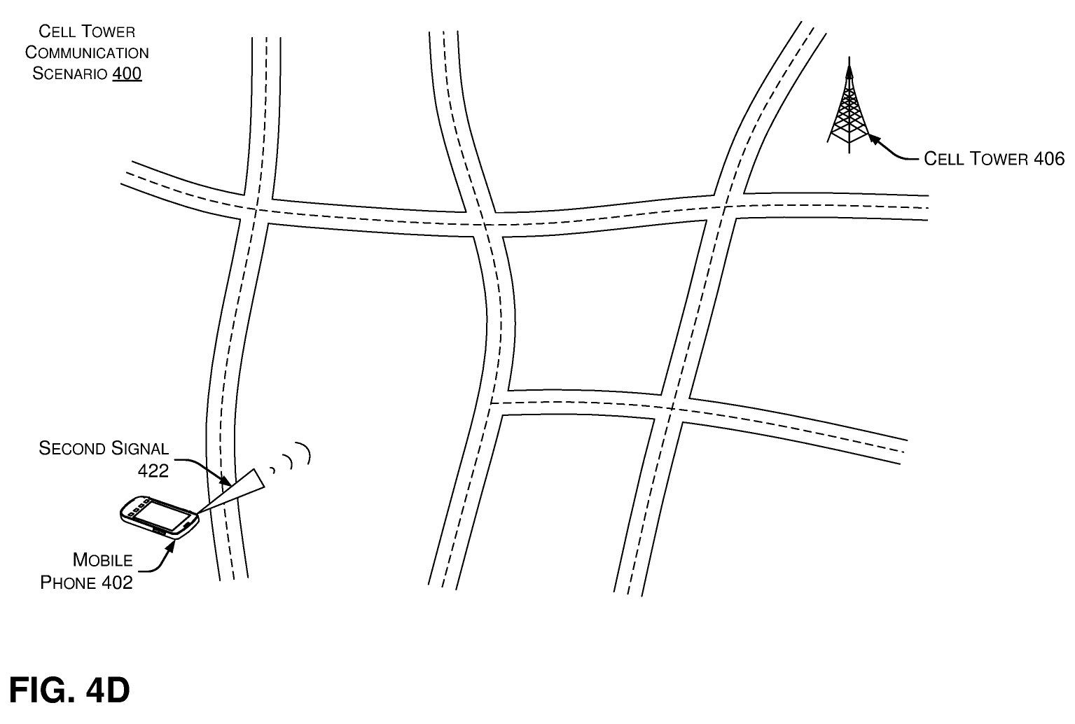

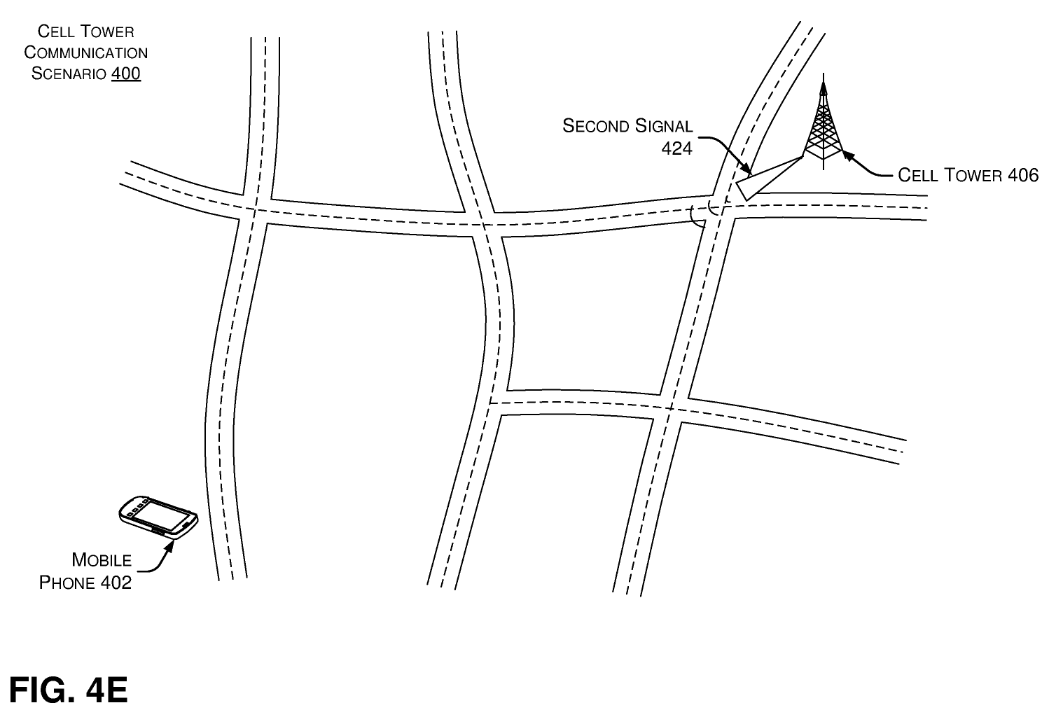

FIGS. 4A through 4E illustrate a cell tower communication scenario 400. In FIG. 4A, a mobile phone 402 transmits a first signal 404 searching for a cell tower 406, where the mobile phone and/or cell tower can each include an instance of wireless communication circuit 100. For instance, the first signal can be a pilot signal that carries information for synchronization and channel estimation at frequency f1, transmitted by an instance of radio 110 on the mobile phone. As shown, the first signal is not in the direction of the cell tower, so the cell tower does not receive the first signal 404 and thus does not a transmit a response. The pilot signal can have predetermined characteristics (e.g., frequency, symbol sequence, a unique identifier) that are known to the cell tower so that the cell tower can identify the pilot signal.

In FIG. 4B, the mobile phone 402 transmits another first signal 408 in another direction, toward the cell tower 406. For instance, first signal 408 can be another pilot signal. First signal 408 can take a direct path 410 to the cell tower, as well as a reflected path 412 off of building 414. The cell tower detects a received pilot signal from both the direct path and the reflected path. Note that the mobile phone can send pilot signals in different directions concurrently in some implementations.

In FIG. 4C, the cell tower 406 responds with a first signal 416, e.g., at frequency f1 using its own instance of radio 110. The cell tower can determine a direction in which to transmit the first signal 416 based on the received first signal 408. First signal 416 takes a direct path 418 to the mobile phone, and also a reflected path 420 off of building 414. Note that the direct and reflected paths shown in FIGS. 4B and 4C are similar except for their direction of travel. This is a result of multipath reciprocity since each first signal may be using the same frequency f1. The cell tower 406 can include channel sounding data, such as channel state information, in the first signal 416. The channel sounding data can convey the properties of the wireless channel between the mobile phone and the cell tower, such as signal strength, multipath characteristics, delay characteristics, phase characteristics, one or more codes received in the pilot signal, etc.

As shown in FIG. 4D, the mobile phone 402 can determine the direction to send a second signal 422 to the cell tower, e.g., using an instance of radio 120 and/or radio 130. Referring back to FIG. 1, this can be implemented by processing circuit 140 receiving directional information from radio 110 indicating the direction of the cell tower determined by radio 110. The directional information can include a line-of-sight direction as well as one or more multipath directions determined by the first radio. The processing circuit can instruct either radio 120 and/or radio 130 to initiate a search for the cell tower using the second signal. For instance, the processing circuit can employ calibration data, such as a lookup table, to account for a physical offset between the radios on the user terminal and/or different beamforming characteristics of the respective radios. Said another way, the processing circuit can use the direction of the cell tower as determined by radio 110 as an initial condition or seed value to inform a subsequent search by radio 120 and/or 130. The mobile phone can determine channel sounding data corresponding to the properties of the wireless channel from the previously-received first signal 416 and include that channel sounding data in the second signal 422.

As shown in FIG. 4E, the cell tower 406 can transmit a second signal 424 to the mobile phone 402. The cell tower can determine the direction of the second signal 424 based on the received channel-sounding data and/or the arrival direction of second signal 422. Note that FIG. 4E shows second signal 424 as employing a relatively narrower beamwidth than first signal 416 transmitted by the cell tower in FIG. 4C, but this is not necessarily the case. The mobile phone 402 can still utilize relatively narrow, high-frequency beams for communication with the cell tower at frequencies f2 or f3 even if the cell tower does not also use narrower beams for frequencies f2/f3.

Note that FIGS. 4A-4E illustrate a somewhat more complex scenario than FIGS. 3A-3C, due to multipath effects between the devices. By using channel sounding information, these multipath effects can be mitigated to determine an appropriate direction in which the mobile phone 402 can transmit to the cell tower 406. The direction can be a direct line of sight to the cell tower or a direction of a reflected path to the cell tower, and in either case the search using the higher frequencies can be performed faster when initialized using a direction determined with a lower frequency.

As with FIGS. 3A-3C, the example of FIGS. 4A-4E shows switching from using a wide beam directly to narrow beam once a direction is established. In other implementations described more below, a device can perform multiple iterations of direction finding by progressively switching from a wide beam to progressively narrower, higher frequency beams until a final direction is established (e.g., using f2 as an intermediate direction finding frequency and f3 for the communication link). As also described below, in some implementations, the mobile phone can also periodically switch back to using a lower frequency with a wider beamwidth even while a communication link is maintained using a higher frequency using a narrower beamwidth. This allows the mobile phone to periodically confirm the direction in which to transmit the high frequency communication signals. In addition, note that the signals described above with respect to FIGS. 4A-4E can be communicated in parallel rather than sequentially.

### DRONE AND CAR COMMUNICATION SCENARIO

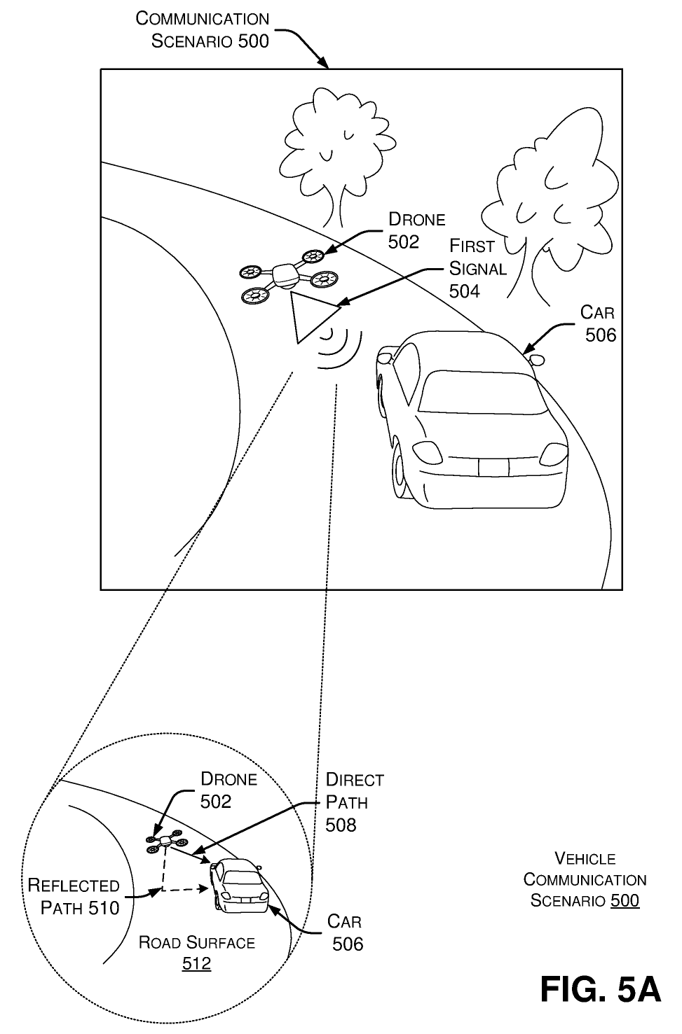

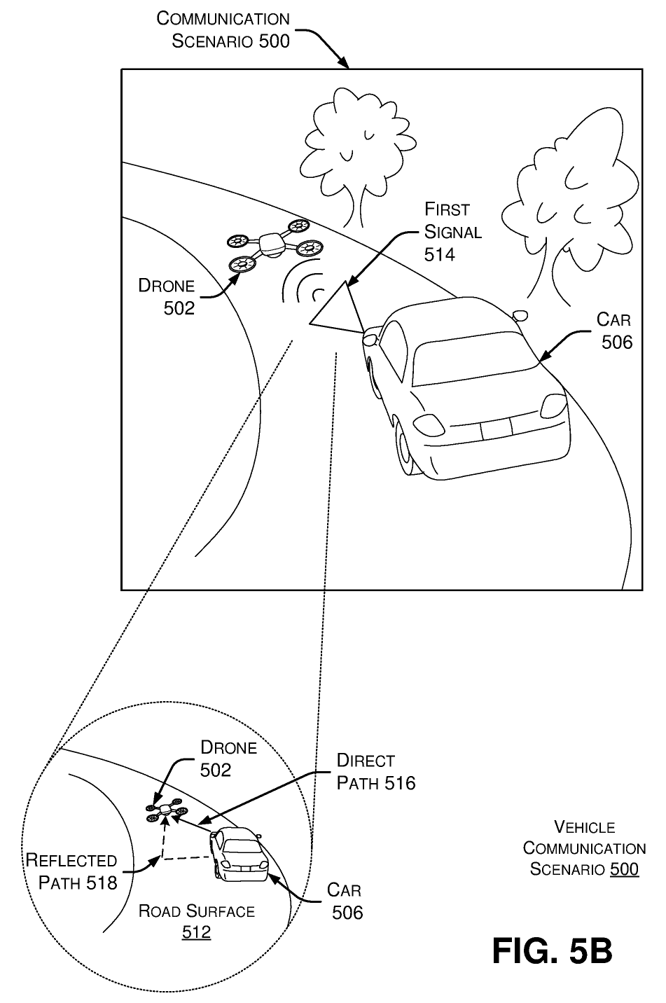

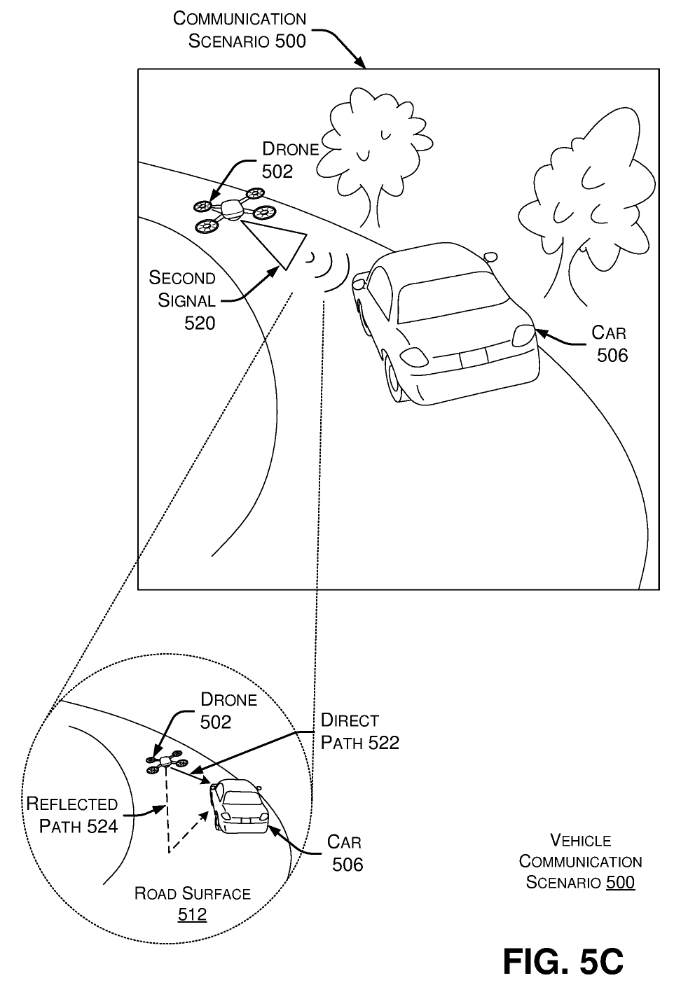

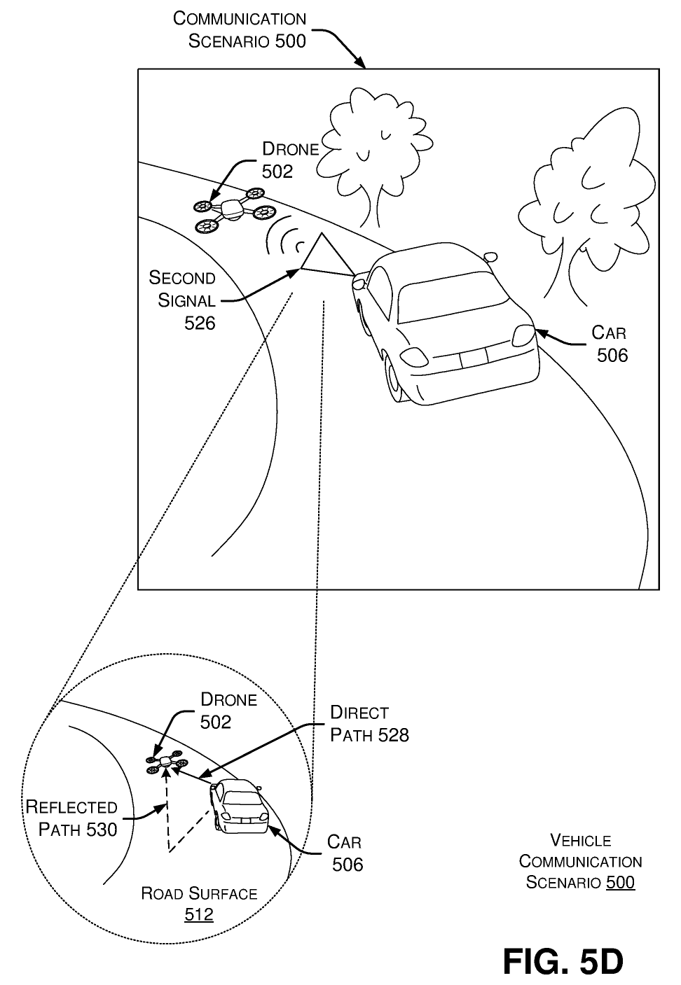

FIGS. 5A through 5D illustrate a vehicle communication scenario 500 involving two moving vehicles. In FIG. 5A, a drone 502 transmits a first signal 504 at frequency f1 searching for a car 506 (e.g., using an instance of radio 110), where both the drone and the car have an instance of wireless communication circuit 100. The first signal 504 can take a direct path 508 from the drone to the car as well as a reflected path 510 off of road surface 512. For instance, the first signal can be a pilot signal as described previously.

In FIG. 5B, the car 506 transmits a first signal 514 back to the drone at frequency f1, e.g., using another instance of radio 110. First signal 514 takes a direct path 516 and a reflected path 518 off road surface 512 to drone 502. The car can include channel sounding data, such as channel state information, in the first signal 514. The channel sounding data can convey the properties of the wireless channel between the drone and the car for frequency f1, such as signal strength, multipath characteristics, delay characteristics, and/or phase characteristics.

In FIG. 5C, the drone 502 transmits a second signal 520 toward car 506 at frequency f2 or f3, e.g., using an instance of radio 120 or radio 130, respectively. The drone can determine the direction of the second signal 520 based on the channel sounding data in the first signal 514 received from the car. The second signal 520 can take a direct path 522 and a reflected path 524 off of road surface 512.

In FIG. 5D, the car 506 transmits a second signal 526 toward the drone 502 at frequency f2 or f3 using another instance of radio 120 or radio 130. The car can determine a direction of second signal 526 based on the channel sounding data in the second signal 520. The second signal 526 takes a direct path 528 and a reflected path 530 off of road surface 512. The car can include channel sounding data, such as channel state information, in the second signal 526. The channel sounding data can convey the properties of the wireless channel between the drone and the car for frequency f2 or f3, such as signal strength, multipath characteristics, delay characteristics, phase characteristics, etc. Note, however, that the signals shown in FIGS. 5C and 5D may have different reflected paths than the signals shown in FIGS. 5A and 5B, because multipath characteristics can be frequency dependent. The direct paths, however, are the same irrespective of frequency.

Note that FIGS. 5A-5D show an example where both communication devices employ certain inventive concepts relating to using relatively wide beamwidths and low frequencies for initial direction finding and relatively narrow beamwidths and high frequencies for communication. However, as described above with respect to FIGS. 3A-3C and 4A-4E, both communication devices do not necessarily need to participate.

### EXAMPLE SCANNING PATTERN

The examples above illustrate how an initial communication link using narrow beams can be established. The following describes additional details on scanning patterns that can be employed to establish initial links and/or to reconnect two devices when a link has been lost.

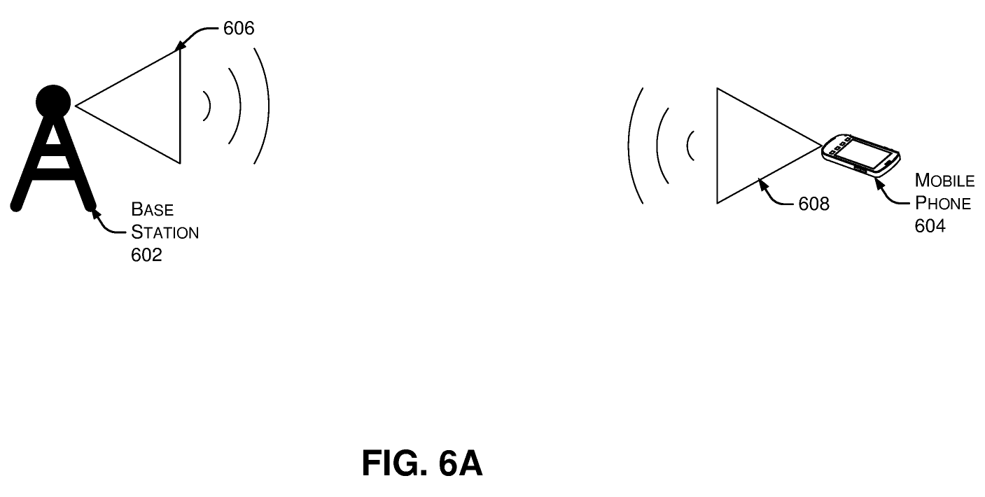

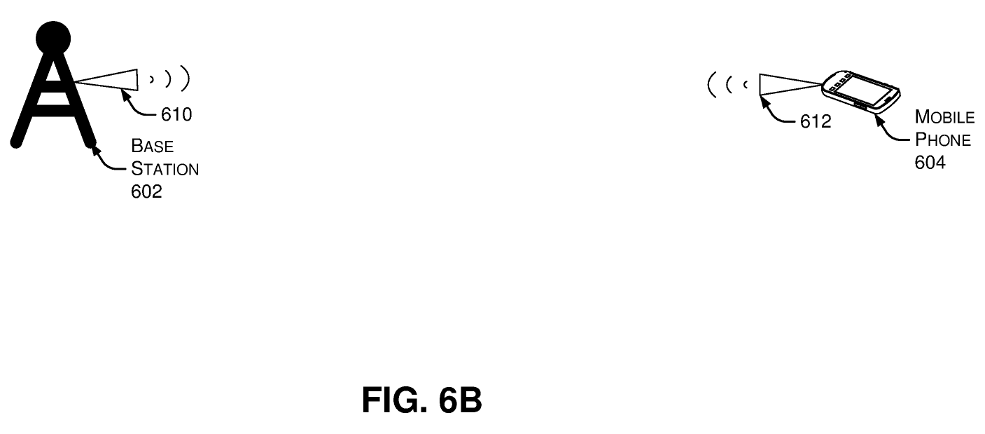

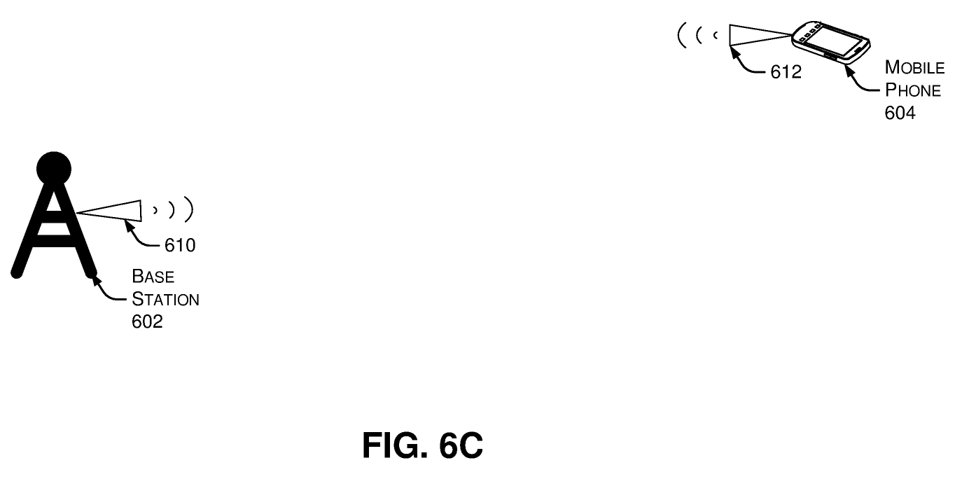

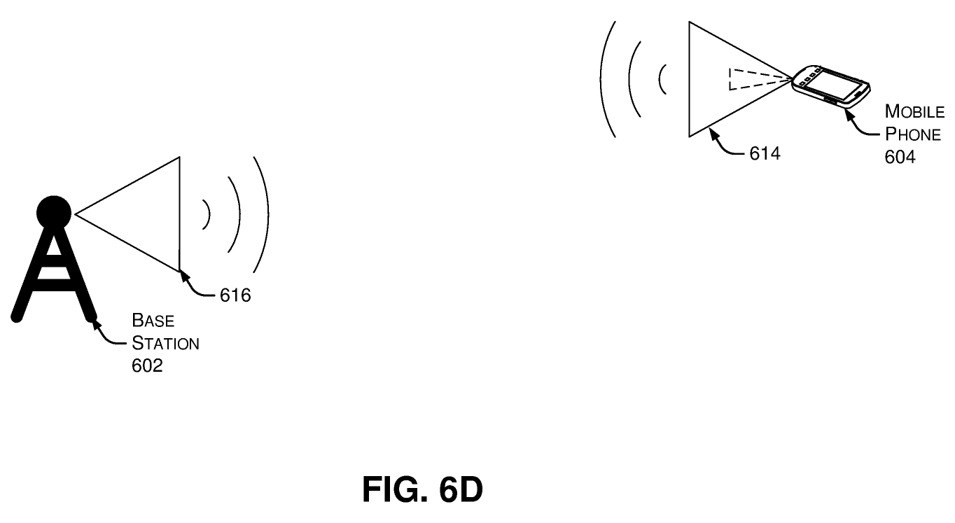

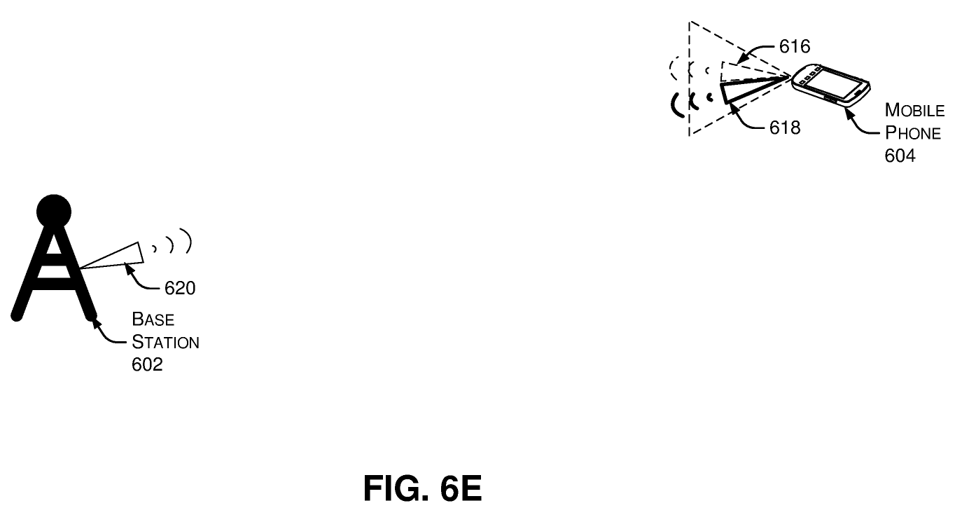

In FIG. 6A, a base station 602 and mobile phone 604 initiate communication, where the base station and/or mobile phone can each have an instance of wireless communication circuit 100. The base station can transmit a first signal 606 to the mobile phone and the mobile phone transmits a first signal 608 to the base station (e.g., at frequency f1 using respective instances of radio 110). The base station and mobile phone can exchange channel sounding data for f1 and determine direction information for each other.

In FIG. 6B, the base station 602 and mobile phone 604 establish a communication link at a higher frequency. For instance, the base station can transmit a second signal 610 and the mobile phone can transmit a second signal 612 at frequency f2 using respective instances of radio 120 and/or at frequency f3 using respective instances of radio 130. Again, note that both devices do not necessarily need to employ narrower beamwidths as shown in FIG. 6B, but this is plausible as a result of using relatively higher frequencies.

In FIG. 6C, the mobile phone 604 moves, and second signal 610 is no longer pointed at the mobile device; and second signal 612 is no longer pointed at the base station 602. Thus, the communication link is lost. The communication link can be reestablished by the mobile phone initiating a scanning pattern as follows.

In FIG. 6D, the mobile phone 604 searches for the base station using a first signal 614 (e.g., at frequency f1 using an instance of radio 110). As shown in FIG. 6D in dotted lines, the first signal 614 is directionally centered on the previously-transmitted second signal 612 from FIG. 6C.

The base station receives the first signal 614 and responds with a first signal 616, again at frequency f1 using an instance of radio 110. The first signal 616 can include channel sounding data for f1 as described previously. Because the mobile phone receives the first signal 616 with the channel sounding data, the mobile phone can infer that the base station is within the beamwidth of the first signal 614.

In FIG. 6E, the mobile phone switches to scanning at the second frequency, e.g., at frequency f2using an instance of radio 120 or frequency f3 using an instance of radio 130. In this example, an initially-transmitted second signal 616 is not directed toward the base station and thus is shown in ghost. The next second signal 618 is correctly directed to the base station, which responds with a second signal 620. The base station can transmit second signal 620 at frequency f2 or f3, using an instance of radio 120 or radio 130 and including channel sounding data for f2/f3.

Various alternative approaches can be employed for scanning patterns. In FIG. 6D, the first signal 614 is centered on the previously-transmitted second signal 612 (e.g., centered on the 3 dB beamwidth of second signal 612 in azimuth and elevation). In implementations, there is no overlap between the first signal used to reestablish a connection and the previously-transmitted second signal employed for a communication. In other implementations, the first signal used to reestablish a connection can partially or entirely overlap the beamwidth of the previously-transmitted second signal used for the communication link that has been lost. For instance, the first signal 614 could have one edge aligned with another edge of the previously-transmitted second signal 612, such that in either case the first signal includes the entire area of the previously-transmitted second signal but is not centered on that second signal.

### EXAMPLE SYSTEM

In the examples described above, a wide range of communication devices are discussed, each of which can include a wireless communication circuit with multiple radios such as wireless communication circuit 100 shown in FIG. 1. For instance, FIGS. 3A-3C show satellite 302 and user terminal 306 as example communication devices, FIGS. 4A-4E show mobile phone 402 and cell tower 406 as example communication devices, FIGS. 5A-5D show drone 502 and car 506 as example communication devices, and FIGS. 6A-6E show base station 602 and mobile phone 604 as example communication devices. Each of these example communication devices can include an instance of wireless communication circuit 100 or another wireless communication circuit capable of communicating over multiple frequency bands. However, these are specific examples of communication scenarios involving specific device types, while the present concepts can be implemented in various technical environments and on various devices.

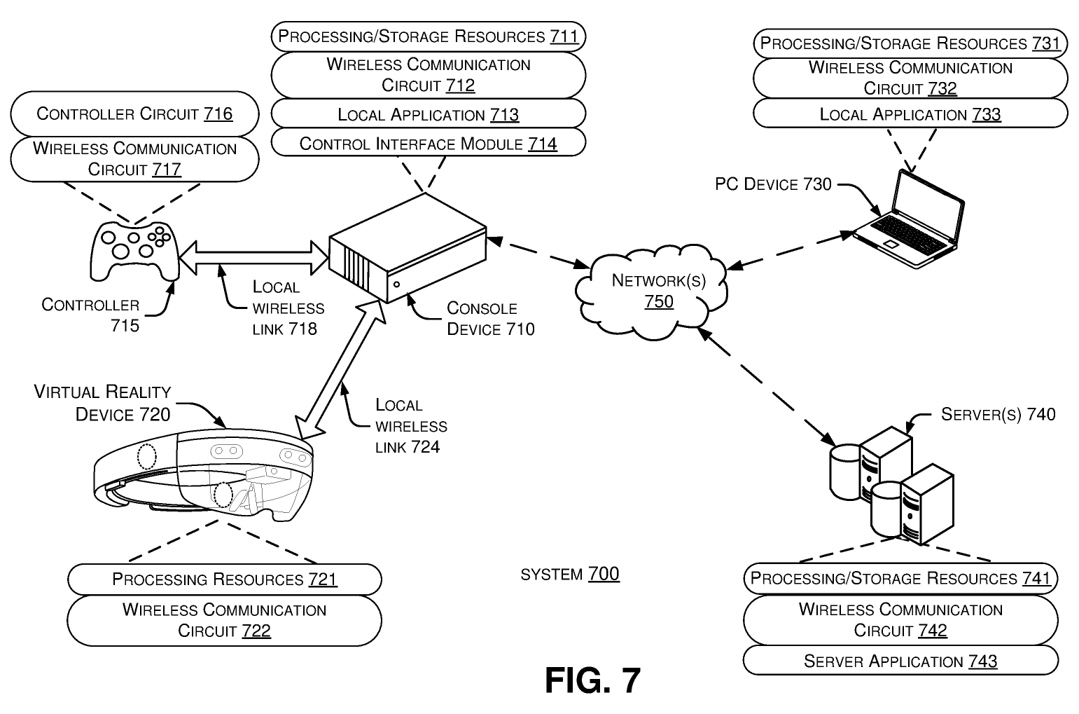

For example, FIG. 7 shows an example system 700 in which the present concepts can be employed using various other types of communication devices. As shown in FIG. 7, system 700 includes a console device 710, a controller 715, a virtual reality device 720, a PC device 730, and server(s) 740. Console device 710, PC device 730, and server(s) 740 are connected over one or more networks 750.

Console device 710 can have processing/storage resources 711 and a wireless communication circuit 712, virtual reality device 720 can have processing/storage resources 721 and a wireless communication circuit 722, PC device 730 can have processing/storage resources 731 and a wireless communication circuit 732, and server(s) 740 can have processing/storage resources 741 and a wireless communication circuit 742. Each of the wireless communication circuits can be implemented as described above with respect to wireless communication circuit 100 in FIG. 1. In addition, as discussed more below, the devices of system 700 may also have various modules that function using the processing and storage resources to perform the techniques discussed herein, as discussed more below.

Console device 710 can include a local application 713 (such as a video game) and a control interface module 714. The local application can interface with one or more server applications, such as streaming video games, executed on server(s) 740, as discussed more below. The control interface module 714 can obtain control inputs from controller 715, which can include a controller circuit 716 and a wireless communication circuit 717, which can be implemented as described above with respect to wireless communication circuit 100 in FIG. 1. The controller circuit can digitize inputs received by various controller mechanisms such as buttons or analog input mechanisms such as joysticks. The wireless communication circuit 717 can communicate the digitized inputs to the console device over a local wireless link 718. The control interface module on the console can obtain the digitized inputs and provide them to the local application, which can in turn send them to the server(s) 740. The local application can also receive game outputs, such as video, chat, and/or audio streams, from the server(s) and output them via a display, loudspeaker, headset, etc. The console device 710 and controller 715 can establish and maintain the local wireless link 718 using the techniques described elsewhere herein.

Virtual reality device 720 can have a head-mounted display, various sensors such as an inertial measurement unit, gaze tracking cameras, external cameras for detecting gestures or providing augmented reality experiences, etc. For instance, the virtual reality device can communicate over a local wireless link 724 with the console device 710, where the local application 713 on the console device is a virtual or augmented reality application. The virtual reality device 720 can send gesture inputs and sensor values to the console device 710 over local wireless link 724, and can receive three-dimensional video, audio, and/or haptic output from the console device. The console device 710 and virtual reality device 720 can establish and maintain the local wireless link 724 using the techniques described elsewhere herein.

PC device 730 can have a local application 733. PC device 730 can have an integrated keyboard and mouse that can be used to provide inputs to control one or more applications executed on server(s) 740. The local application can send inputs from the keyboard, mouse, and/or peripheral game controller to the server(s) 740, and can also receive output from the server application 743. For instance, when the server application is a streaming video game, the outputs can include video, chat, and/or audio streams sent from the server(s) and the PC client device can output them via a display, loudspeaker, headset, etc.

Server(s) 740 can execute a server application 743 that communicates with any of the other devices and/or local applications shown in FIG. 7. Both the PC device 730 and the server(s) 740 can use the techniques described herein to access network(s) 750. For instance, network(s) 750 can include communication devices such as access points, base stations, routers, switches, hubs, cell towers, satellites, etc. PC device 730 and/or server(s) 740 can establish wireless links with any of these devices using the techniques described herein.

### FIRST EXAMPLE METHOD

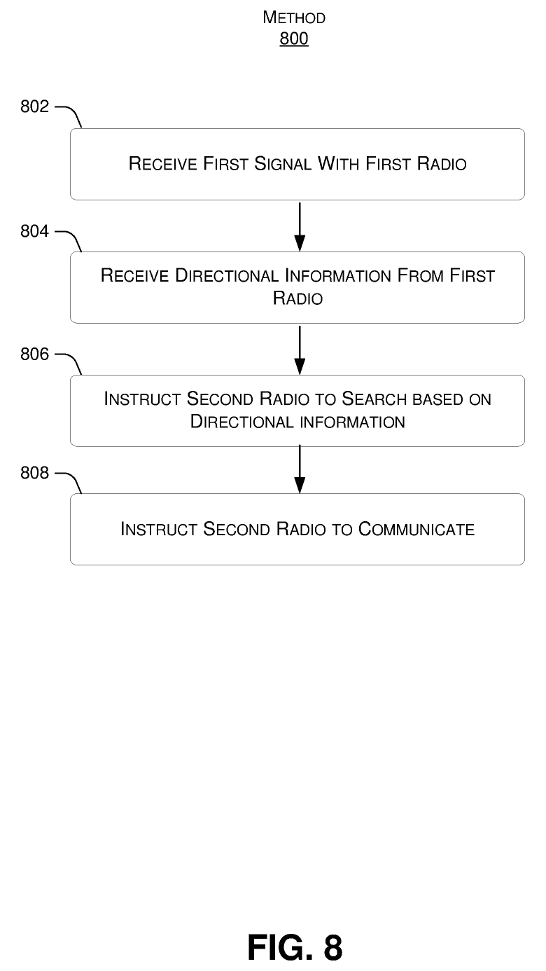

FIG. 8 illustrates an example computer-implemented method 800, consistent with some implementations of the present concepts. Method 800 can be performed by a communication device, such as a laptop, a tablet, a smartphone, a wireless access point, a communication device in a vehicle, or any other type of communication device.

Method 800 begins at block 802, where one or more first signals are received with a first radio configured to communicate in a first frequency band. For example, the one or more first signals can include a beacon signal transmitted by another communication device.

Method 800 continues at block 804, where directional information for the another communication device is received from the first radio. For instance, the first radio may have determined the directional information based at least on angle of arrival of the one or more first signals.

Method 800 continues at block 806, where a second radio is instructed to initialize a search for the another communication device based at least on the directional information received from the first radio. The second radio can be configured to communicate in a second frequency band that is relatively higher than the first frequency band. For example calibration data, such as a lookup table, can be employed to account for alignment differences between the first radio and the second radio.

Method 800 continues at block 808, where the second radio is instructed to communicate with the another computing device over a communication link. For example, the second radio can establish the communication link by scanning based on the instruction received at block 806.

### ADDITIONAL DETAILS ON DIRECTION DETERMINATION FOR FIRST METHOD

As noted above, block 804 of method 800 involves receiving directional information from a first radio indicating the direction of another communication device. The direction is determined by the first radio based on angle of arrival processing of a wider, lower-frequency beam received at the communication device, such as a beacon signal. One way to determine the direction of the second beam involves received signal strength analysis. For instance, referring back to FIGS. 3A-3C, the user terminal 306 can include an instance of wireless communication circuit 100. Radio 110 can be tuned to the frequency of the beacon signal, and the radio can adjust focus using one or more of the antenna elements (e.g., by mechanical steering or phase shifting of antenna elements) until the received signal strength at the frequency of the beacon signal is highest. The direction where the signal is strongest is the direction of the satellite.

As another example, the radio 110 can measure phase differences across multiple array elements (e.g., of a phased array). The phase differences can be employed to determine the angle of arrival of the beacon signal at the user terminal 306. In some cases, the doppler shift can also be measured to estimate the trajectory of the satellite relative to the wireless access point. This directional information can be used to initialize a search for the another communication device using radio 120 and/or radio 130, which can be used to search for the another communication device using relatively narrower beamwidths carrying signals at one or more higher frequencies.

### SECOND EXAMPLE METHOD

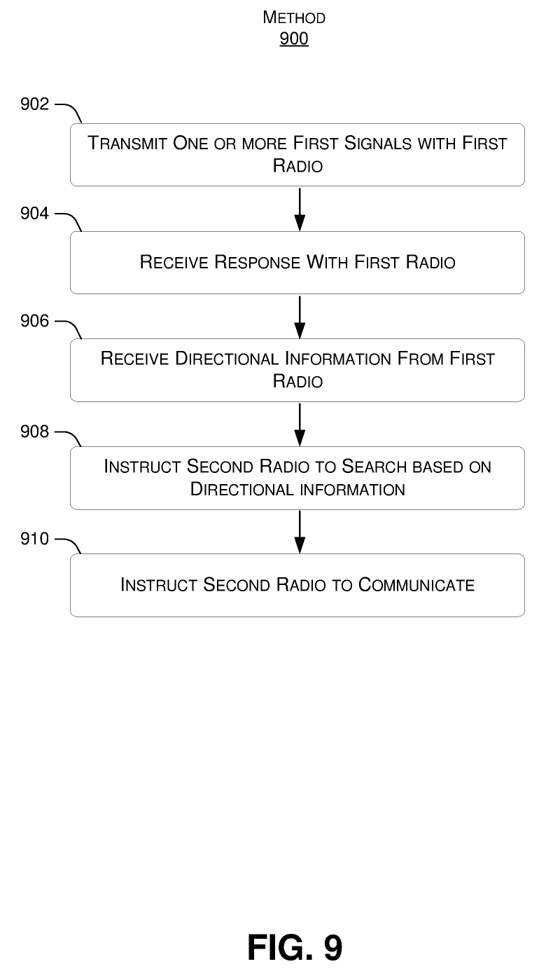

FIG. 9 illustrates an example computer-implemented method 900, consistent with some implementations of the present concepts. Method 900 can be performed by a communication device, such as a laptop, a tablet, a smartphone, a wireless access point, a communication device in a vehicle, or any other type of communication device.

Method 900 begins at block 902, where one or more first signals are transmitted with a first radio configured to communicate in a first frequency band. For example, the one or more first signals can include coded pilot signals.

Method 900 continues at block 904, where a response to the first signal is received with the first radio. For instance, the response can be received from another communication device. The response can represent channel conditions for the first frequency estimated by the another communication device based on the pilot signal. The response can also identify a particular code that was received by the another computing device via the pilot signal.

Method 900 continues at block 906, where directional information for the another communication device is received from the first radio. For instance, the first radio may have determined the directional information based at least on the channel conditions received from the another communication device.

Method 900 continues at block 908, where a second radio is instructed to initialize a search for the another communication device based at least on the directional information received from the first radio. The second radio can be configured to communicate in a second frequency band that is relatively higher than the first frequency band. For example calibration data, such as a lookup table, can be employed to account for alignment differences between the first radio and the second radio.

Method 900 continues at block 910, where the second radio is instructed to communicate with the another computing device over a communication link. For example, the second radio can establish the communication link by scanning based on the instruction received at block 908.

### ADDITIONAL DETAILS ON DIRECTION DETERMINATION FOR SECOND METHOD

As noted above, block 906 of method 900 involves receiving directional information that is determined by a first radio based on channel conditions estimated by another communication device for a signal transmitted in a first frequency band. The first signal was previously transmitted by the first radio to the another computing device, such as a pilot signal. For instance, referring back to FIG. 1, the mobile phone 402 can include an instance of wireless communication circuit 100. Radio 110 can transmit first signal 404 as shown in FIG. 4B as a pilot signal.

Next, referring back to FIG. 4C, the cell tower 406 can send channel sounding data, such as channel state information, to the mobile phone 402 via first signal 416. For instance, the channel sounding data can include angle of arrival information for the first signal 408 shown in FIG. 4B (e.g., a pilot signal), and can include complex channel coefficients for respective pairs of antenna elements on the cell tower and the mobile phone, a code received in the pilot signal, etc. In some cases, the channel sounding data can correspond to a particular standard, e.g., different frequency bands can have corresponding standards for what channel sounding data is communicated among devices, how the channel sounding data is formatted, etc.

The mobile phone can receive the channel sounding data at the first frequency using radio 110. In some cases, the response to the pilot signal can include angle of arrival information as described previously. Thus, for example, the cell tower 406 can send back the angle of arrival of the pilot signal to the mobile phone 402. This can be used by the mobile phone to steer a beam toward the cell tower using radio 120 and/or radio 130.

In other cases, the channel state information can include channel gains for different directions in space. The mobile phone can steer the second beam toward the direction with the highest gain. As another example, the channel state information can include phase and amplitude information for each antenna element of the radio 110 and corresponding antenna elements on the cell tower. Then, the processing circuit 140 can use the received phase and amplitude information for beamforming by estimating a direction vector toward the cell tower. Then, the direction vector is employed to adjust the phase and/or amplitude of a signal emitted by each antenna element of radio 120 and/or 130.

### ADDITIONAL IMPLEMENTATIONS

As noted above, the processing circuit 140 in FIG. 1 can receive direction information from each respective radio indicating the direct path to the other communication device, and then instruct the other radios to initialize their search algorithms based on the direct paths identified by the radios. Several approaches exist for determining the direct path.

As noted above, channel state information can include information relating to path delays. Generally speaking, the direct path will have a shorter delay than any of the reflected paths. Thus, a radio can identify the direct path as the path having the shortest delay in the channel state information for a given frequency, and use that direct path to determine the directional information shared with the processing circuit.

As another example, reflected paths for different frequencies tend to have different path gains, because they are scattered and reflected differently on the different paths and also because different antennas used for those frequencies may have different gains. However, the differences in path gain across different frequencies can be predictable. Thus, in some implementations, path gains received from different radios can be employed as directional information by the processing circuit 140 by compensating for differences in antenna gain to distinguish reflected paths from a direct path between any two communication devices. In addition, the direct path has the same travel distance and will exhibit a corresponding phase shift at different frequencies that corresponds to the travel distance. On the other hand, different reflected paths will have different travel distances and thus the phase shift at f1 for one reflected path will correspond to a different travel distance than another phase shift for f2 along a different reflected path.

In addition, the received signal strength can also be used to determine the direct path. If a transmitted signal is aligned with the direct path to the receiving device, then the signal strength will be higher than if the signal is not centered on the direct path. On the other hand, a lower received signal strength implies that the signal is not pointed directly at the other communication device. Thus, signal strength information received from a given radio can be employed as another type of directional information used by the processing circuit 140 to initialize a search using another radio.

Note that multipath directional information received from one radio can also be used to initialize a search using another radio. For instance, radio 110 may identify several multipath directions that exhibit high signal quality at the receiving device. These multipath directions can be employed to initialize the search by radio 120 and/or 130, so that radios 120 and/or 130 try those directions first when performing their own independent search. This can facilitate radio 120 and/or 130 to more quickly identify suitable reflected paths to employ for a communication link.

As another point, note that the antenna elements for the respective radios may be in different physical locations on a given communication device. As a consequence of the spatial relationship of the antenna elements as well as the beamforming characteristics of each radio, any signal transmitted by one of the radios can be spatially offset from signals transmitted by the other radios. To correct for this spatial offset, a coordinate system can be defined for each radio and then the direction determined using one radio can be translated into a coordinate system for another radio. In other cases, a lookup table and/or a machine learning model can be employed to account for this spatial relationship. For instance, the lookup table or machine learning model may map an azimuth and elevation determined by one radio to adjusted transmission parameters for use by another radio, such as a different azimuth and/or elevation for use by another radio, different beamforming parameters (e.g., phase or gain adjustments) for use by the other radio, etc.

In some cases, the calibration data is provided during manufacture on a given communication device based on analysis of spatial offsets and/or beamforming characteristics of individual radios. In other cases, the calibration data can be updated at runtime. For instance, consider a scenario where a metallic object (such as a coin) temporarily interferes with signal transmission or reception by one of the radios on a device. This can be detected, for example, by analyzing the direct path to another communication device reported by both radios. The direct path should exhibit a consistent offset over time assuming no physical interference. If one radio is temporarily experiencing interference from a physical object that is not affecting another radio, the calibration data can be temporarily adjusted to account for the interference.

Also, note that the disclosed techniques can be readily extended to scenarios where different radios employ the same frequency bands, but have antennas with different gains. For instance, assume radio 110, radio 120, and radio 130 each employ the same frequency band, but radio 110 has a relatively lower gain antenna than radio 120 and radio 120 has a relatively lower gain antenna than radio 130. As a consequence, radio 110 may have a wider beamwidth than radio 120, which may in turn have a relatively wider beamwidth than radio 130. By using directional information from radio 110 to initialize a search for another communication device using radios 120 and/or 130, the searches performed using radio 120 and/or 130 can be performed efficiently in the same frequency band employed by radio 110 for initial direction finding.

### TECHNICAL EFFECT

As noted above, omnidirectional antennas tend to waste power and can also crowd the radio spectrum. While approaches such as beam steering can make more efficient use of power and radio spectrum, it is difficult to maintain a reliable communication link. For instance, complex terrain, moving devices, weather conditions, and/or transmissions by other communication devices can cause communication devices to lose track of one another when communicating at high frequencies, due to the relatively narrower beamwidths typically employed at high frequencies. Approaches such as beam training tend to involve an extensive search in the same frequency band as the communication link, which can be wasteful particularly when narrow beams are used for beam training.

In the disclosed implementations, relatively lower-frequency, wider beamwidths are employed to inform the direction of a higher-frequency communication signal with a narrower beam width. By using a lower-frequency signal with a wider beamwidth to determine the location in which to transmit a higher-frequency signal with a narrower beamwidth, several technical benefits are achieved. For instance, the search can conclude more quickly, as wider beamwidths can cover a greater search area than narrow beamwidths. Furthermore, less power is utilized as a result of faster completion of the search to establish an initial communication link. Moreover, by periodically using a lower-frequency signals to find the direction of another device after a communication link has been established, the communication link itself can be more reliable than techniques that rely on higher-frequency communication links to infer direction information.

Further, note that some radios may implement proprietary and/or hard-coded direction-finding algorithms that cannot be readily modified. In many cases, a given radio may be designed to find the direction of another communication device without necessarily receiving directional assistance from another radio. Using the disclosed techniques, one radio can be initialized using directional information received from another radio, without necessarily modifying the logic or hardware of the radios themselves. Thus, by sharing directional information among multiple independent radios using a separate processing circuit (e.g., processing circuit 140 shown in FIG. 1), it is possible to reduce the amount of time that each radio uses to complete its search for another communication device without modifications to the radios themselves.

### DEVICE IMPLEMENTATIONS

The examples and figures introduced above show various types of communication devices. As also noted, not all device implementations can be illustrated, and other device implementations should be apparent to the skilled artisan from the description above and below. The term “device”, "computer,” "computing device," “client device,” “communication device,” and/or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore and, when executed, can cause a processor to perform acts. The term “system” as used herein can refer to a single device, multiple devices, etc.

Storage resources can be internal or external to the respective devices with which they are associated. The storage resources can include any one or more of volatile or non-volatile memory, hard drives, solid state drives, flash storage devices, and/or optical storage devices (e.g., CDs, DVDs, etc.), among others. As used herein, the terms "computer-readable media" and "computer-readable medium" can include signals. In contrast, the terms "computer-readable storage media" and "computer-readable storage medium" excludes signal. Computer-readable storage media includes "computer-readable storage devices." Examples of computer-readable storage devices include volatile storage media, such as RAM, and non-volatile storage media, such as hard drives, optical discs, solid state drives, flash memory, etc.

In some cases, the devices are configured with a general-purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), neural processing units (NPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, speakers, etc.

Also note that the devices described herein can function in a stand-alone or cooperative manner to implement the described techniques. For example, the methods and functionality described herein can be performed on a single computing device and/or distributed across multiple computing devices that communicate over network(s) 750. Without limitation, network(s) 750 can include one or more local area networks (LANs), wide area networks (WANs), the Internet, and the like.

### ADDITIONAL EXAMPLES

Various examples are described above. Additional examples are described below. One example includes a computer-implemented method performed by a communication device, the computer-implemented method comprising receiving, with a first radio configured to communicate in a first frequency band, one or more first signals transmitted in the first frequency band by another communication device, receiving, from the first radio, directional information for the another communication device, the directional information of the another communication device having been determined by the first radio based at least on angle of arrival of the one or more first signals, instructing a second radio to initialize a search for the another communication device based at least on the directional information received from the first radio, the second radio being configured to communicate in a second frequency band that is relatively higher than the first frequency band, and instructing the second radio to communicate with the another communication device over a communication link established via the search, where the second radio performs the search and establishes the communication link by transmitting one or more second signals in the second frequency band.

Another example can include any of the above and/or below examples where the method further comprises receiving the one or more first signals with multiple first antenna elements of the first radio of the communication device and transmitting the one or more second signals with multiple second antenna elements of the second radio of the communication device.

Another example can include any of the above and/or below examples where the first antenna elements are elements of a first phased array of first radio, the second antenna elements are elements of a second phased array of the second radio.

Another example can include any of the above and/or below examples where one or more first signals correspond to a beacon signal having one or more predetermined characteristics known to the communication device.

Another example can include any of the above and/or below examples where the method further comprises maintaining the communication link with the another communication device using the second radio while repeatedly instructing the second radio to adjust direction of the one or more second signals based on further directional information received from the first radio.

Another example can include any of the above and/or below examples where instructing the second radio to initiate the search comprises employing calibration data to account for alignment differences between the first radio and the second radio.

Another example includes a computer-implemented method performed by a communication device, the computer-implemented method comprising using a first radio configured to communicate in a first frequency band to transmit one or more first signals in the first frequency band and receive at least one response to one or more first signals from another communication device, the at least one response representing channel conditions for the first frequency band estimated by the another communication device based on the one or more first signals. The method can also comprise receiving, from the first radio, directional information for the another communication device, the directional information for the another communication device being determined by the first radio based at least on the channel conditions for the first frequency band received from the another communication device, instructing a second radio to initialize a search for the another communication device based at least on the directional information received from the first radio, the second radio being configured to communicate in a second frequency band that is relatively higher than the first frequency band, and instructing the second radio to communicate with the another communication device over a communication link established via the search, where the second radio performs the search and establishes the communication link by transmitting one or more second signals in the second frequency band.

Another example can include any of the above and/or below examples where the method further comprises transmitting the one or more first signals and receiving the at least one response with multiple first antenna elements of the first radio and transmitting the one or more second signals with multiple second antenna elements of the second radio.

Another example can include any of the above and/or below examples where the first antenna elements are elements of a first phased array of first radio, the second antenna elements are elements of a second phased array of the second radio.

Another example can include any of the above and/or below examples where the at least one response received from the another communication device includes complex channel coefficients for respective pairs of first antenna elements of the communication device and other first antenna elements of the another communication device.

Another example can include any of the above and/or below examples where the one or more first signals comprise a pilot signal having one or more predetermined characteristics known to the another communication device.

Another example can include any of the above and/or below examples where the method further comprises maintaining the communication link with the another communication device using the second radio while repeatedly instructing the second radio to adjust direction of the one or more second signals based on further directional information received from the first radio.

Another example can include any of the above and/or below examples where the first radio employs a first beamwidth for the one or more first signals that is relatively wider than a second beamwidth used by the second radio for the one or more second signals.

Another example can include any of the above and/or below examples where the first radio transmits the one or more first signals having the first beamwidth concurrently with the second radio transmitting the one or more second signals having the second beamwidth.

Another example can include any of the above and/or below examples where the method further comprises receiving one or more multipath directions identified by the first radio and instructing the second radio to initialize the search based on the one or more multipath directions identified by the first radio.

Another example can include any of the above and/or below examples where the second radio performs the search using a scanning pattern that is determined based on the directional information received from the first radio.

Another example can include any of the above and/or below examples where instructing the second radio to initiate the search comprises employing calibration data to account for alignment differences between the first radio and the second radio.

Another example can include any of the above and/or below examples where the calibration data comprises a lookup table that maps the directional information received from the first radio to transmission parameters for the second radio to employ when transmitting the one or more second signals.

Another example include a communication device comprising a wireless communication circuit having a first radio with multiple first antenna elements and a second radio with multiple second antenna elements, the first radio being configured to communicate in a first frequency band and the second radio being configured to communicate in a second frequency band that is higher than the first frequency band and a processing circuit in communication with the first radio and the second radio. The first radio can be configured to transmit one or more first signals in the first frequency band and receive at least one response to the one or more first signals from another communication device, the at least one response representing channel conditions for the first frequency band estimated by the another communication device based on the one or more first signals. The processing circuit can be configured to receive, from the first radio, directional information for the another communication device, the directional information for the another communication device being determined by the first radio based at least on the channel conditions for the first frequency band received from the another communication device, instruct the second radio to initialize a search for the another communication device based at least on the directional information received from the first radio, and instruct the second radio to communicate with the another communication device over a communication link established via the search. The second radio can be configured to perform the search and establish the communication link by transmitting one or more second signals in the second frequency band.

Another example can include any of the above and/or below examples where the first radio and the second radio implement independent direction-finding algorithms to determine the direction of the another communication device.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method performed by a communication device, the computer-implemented method comprising:
receiving, with a first radio configured to communicate in a first frequency band, one or more first signals transmitted in the first frequency band by another communication device;
receiving, from the first radio, directional information for the another communication device, the directional information of the another communication device having been determined by the first radio based at least on angle of arrival of the one or more first signals;
instructing a second radio to initialize a search for the another communication device based at least on the directional information received from the first radio, the second radio being configured to communicate in a second frequency band that is relatively higher than the first frequency band; and
instructing the second radio to communicate with the another communication device over a communication link established via the search,
wherein the second radio performs the search and establishes the communication link by transmitting one or more second signals in the second frequency band.

2. The computer-implemented method of claim 1, further comprising:
receiving the one or more first signals with multiple first antenna elements of the first radio of the communication device; and
transmitting the one or more second signals with multiple second antenna elements of the second radio of the communication device.

3. The computer-implemented method of claim 2, the first antenna elements being elements of a first phased array of first radio, the second antenna elements being elements of a second phased array of the second radio.

4. The computer-implemented method of claim 1, one or more first signals corresponding to a beacon signal having one or more predetermined characteristics known to the communication device.

5. The computer-implemented method of claim 1, further comprising:
maintaining the communication link with the another communication device using the second radio while repeatedly instructing the second radio to adjust direction of the one or more second signals based on further directional information received from the first radio.

6. The computer-implemented method of claim 1, wherein instructing the second radio to initiate the search comprises employing calibration data to account for alignment differences between the first radio and the second radio.

7. A computer-implemented method performed by a communication device, the computer-implemented method comprising:
using a first radio configured to communicate in a first frequency band:
transmitting one or more first signals in the first frequency band; and
receiving at least one response to one or more first signals from another communication device, the at least one response representing channel conditions for the first frequency band estimated by the another communication device based on the one or more first signals;
receiving, from the first radio, directional information for the another communication device, the directional information for the another communication device being determined by the first radio based at least on the channel conditions for the first frequency band received from the another communication device;
instructing a second radio to initialize a search for the another communication device based at least on the directional information received from the first radio, the second radio being configured to communicate in a second frequency band that is relatively higher than the first frequency band; and
instructing the second radio to communicate with the another communication device over a communication link established via the search,
wherein the second radio performs the search and establishes the communication link by transmitting one or more second signals in the second frequency band.

8. The computer-implemented method of claim 7, further comprising:
transmitting the one or more first signals and receiving the at least one response with multiple first antenna elements of the first radio; and
transmitting the one or more second signals with multiple second antenna elements of the second radio.

9. The computer-implemented method of claim 8, the first antenna elements being elements of a first phased array of first radio, the second antenna elements being elements of a second phased array of the second radio.

10. The computer-implemented method of claim 9, the at least one response received from the another communication device including complex channel coefficients for respective pairs of first antenna elements of the communication device and other first antenna elements of the another communication device.

11. The computer-implemented method of claim 7, the one or more first signals comprising a pilot signal having one or more predetermined characteristics known to the another communication device.

12. The computer-implemented method of claim 7, further comprising:
maintaining the communication link with the another communication device using the second radio while repeatedly instructing the second radio to adjust direction of the one or more second signals based on further directional information received from the first radio.

13. The computer-implemented method of claim 7, the first radio employing a first beamwidth for the one or more first signals that is relatively wider than a second beamwidth used by the second radio for the one or more second signals.

14. The computer-implemented method of claim 13, wherein the first radio transmits the one or more first signals having the first beamwidth concurrently with the second radio transmitting the one or more second signals having the second beamwidth.

15. The computer-implemented method of claim 14, further comprising:
receiving one or more multipath directions identified by the first radio; and
instructing the second radio to initialize the search based on the one or more multipath directions identified by the first radio.

16. The computer-implemented method of claim 15, wherein the second radio performs the search using a scanning pattern that is determined based on the directional information received from the first radio.

17. The computer-implemented method of claim 7, wherein instructing the second radio to initiate the search comprises employing calibration data to account for alignment differences between the first radio and the second radio.

18. The computer-implemented method of claim 17, wherein the calibration data comprises a lookup table that maps the directional information received from the first radio to transmission parameters for the second radio to employ when transmitting the one or more second signals.

19. A communication device comprising:
a wireless communication circuit having a first radio with multiple first antenna elements and a second radio with multiple second antenna elements, the first radio being configured to communicate in a first frequency band and the second radio being configured to communicate in a second frequency band that is higher than the first frequency band; and
a processing circuit in communication with the first radio and the second radio,
the first radio being configured to:
transmit one or more first signals in the first frequency band; and
receive at least one response to the one or more first signals from another communication device, the at least one response representing channel conditions for the first frequency band estimated by the another communication device based on the one or more first signals;
the processing circuit being configured to:
receive, from the first radio, directional information for the another communication device, the directional information for the another communication device being determined by the first radio based at least on the channel conditions for the first frequency band received from the another communication device;
instruct the second radio to initialize a search for the another communication device based at least on the directional information received from the first radio; and
instruct the second radio to communicate with the another communication device over a communication link established via the search,
the second radio being configured to perform the search and establish the communication link by transmitting one or more second signals in the second frequency band.

20. The communication device of claim 19, wherein the first radio and the second radio implement independent direction-finding algorithms to determine the direction of the another communication device.
